(19) United States
(12) Patent Application Publication
(10) Pub. No.: US 2024/0019556 A1
(43) Pub. Date: Jan. 18, 2024

(54) STORAGE METHOD, DATA PROCESSING METHOD, LIDAR, AND COMPUTER-READABLE STORAGE MEDIUM

(71) Applicant: HESAI TECHNOLOGY CO., LTD., Shanghai (CN)

(72) Inventors: Jin YANG, Shanghai (CN); Shuaiqi XU, Shanghai (CN); Hongyan ZHANG, Shanghai (CN); Shaoqing XIANG, Shanghai (CN)

(73) Assignee: HESAI TECHNOLOGY CO., LTD., Shanghai (CN)

(21) Appl. No.: 18/477,692

(22) Filed: Sep. 29, 2023

Related U.S. Application Data
(63) Continuation of application No. PCT/CN2021/138329, filed on Dec. 15, 2021.

(30) Foreign Application Priority Data
Mar. 31, 2021 (CN) 202110351505.2

(51) Int. Cl. G01S 7/4865; G01S 17/894

(52) U.S. Cl. CPC G01S 7/4865; G01S 17/894

(57) ABSTRACT

A storage method for detection data of a lidar, a data processing method for a lidar, a lidar, and a computer-readable storage medium are provided. The storage method includes: S101: receiving a detection data, the detection data including time information and intensity information corresponding to the time information; and S102: storing the intensity information with a first time precision based on a weight of the time information. The first time precision is a time interval between any two adjacent first time scales, and is n times the time resolution of the detection data of the lidar, and n>1. The weight is associated with a time interval between the time information and at least one first time scale. The storage method can maintain a ranging precision while reducing a storage space.

### CROSS-REFERENCE TO RELATED APPLICATIONS

This application is a bypass Continuation of International Patent Application No. PCT/CN2021/138329, filed Dec. 15, 2021, which claims priority to Chinese Patent Application No. 202110351505.2, filed Mar. 31, 2021; the disclosures of all of which are incorporated herein by reference in their entirety.

### TECHNICAL FIELD

The present disclosure generally relates to the field of photoelectric detection technologies, and in particular, to a storage method for a detection data of a lidar, a data processing method, Light Detection and Ranging (LIDAR), and a computer-readable storage medium.

### BACKGROUND

A lidar is a radar system that detects characteristic quantities such as a location and a velocity of a target object by emitting laser beams, which is an advanced detection method that combines laser technology with photoelectric detection technology. The lidar has been widely used in fields such as unmanned vehicles, traffic communication, unmanned aerial vehicles, intelligent robots, and resource exploration, by virtue of advantages such as a high resolution, desirable concealment, a strong anti-active jamming ability, desirable low-altitude detection performance, a small size, and a light weight.

In the lidar, a time digital converter is usually used to obtain a time information, including an arrival time of an echo and/or a time of flight (TOF) of the echo. In a measurement system based on a high-precision time-to-digital converter (TDC), a time information measured each time is accumulated into a histogram, which occupies a lot of storage space. Certain lidars use a device like a single photon avalanche diode (SPAD) as a detector. Avalanche of the SPAD may be triggered by a single photon. The TDC can provide a picosecond precision measurement for a timestamp of each trigger. In certain applications, a plurality of SPADs form a macro pixel, and output terminals of the plurality of SPADs are connected to the same TDC. The TDC provides a number cnt of SPADs simultaneously triggered in the macro pixel while providing timestamp of trigger moment.

In such a storage and ranging method, since a precision unit of the timestamp of trigger moment is in the order of picoseconds, it requires a large amount of memory and consumes an enormous amount of memory space to store a complete histogram when a long-TOF detection is required. In particular, in order to improve the long-range capability, a duration of measurement and a number of repeated measurements need to be increased, which makes a requirement of storage space increase.

The content of the background is merely technologies known to the inventor, and does not represent existing technologies in the art.

### SUMMARY

In view of at least one defect in the prior art, the present disclosure provides a storage method for a detection data of a radar, including:

S101: receiving a detection data, the detection data including a time information and an intensity information corresponding to the time information; and

S102: storing the intensity information with a first time precision according to a weight of the time information,
the first time precision being a time interval between any two adjacent first time scales, and being n times a time resolution of the detection data of a radar, and n>1; and
the weight being associated with a time interval between the time information and at least one first time scale.

According to an aspect of the present disclosure, the weight includes a first weight and a second weight, the first weight being associated with a time interval between the time information and one adjacent first time scale, the second weight being associated with a time interval between the time information and another adjacent first time scale, and step S102 including: storing the intensity information with the first time precision according to the first weight and the second weight.

According to an aspect of the present disclosure, the first weight is n−x, and the second weight is x, x representing a time interval between the time information and an adjacent first time scale divided by the time resolution of the detection data of the lidar.

According to an aspect of the present disclosure, the first weight is a weight of the time information corresponding to a left adjacent first time scale, and the second weight is a weight of the time information corresponding to a right adjacent first time scale, x representing a time interval between the time information and the left adjacent first time scale divided by the time resolution of the detection data of the lidar.

According to an aspect of the present disclosure, the first weight is 1−(x/n), and the second preset weight is x, x representing a time interval between the time information and a left adjacent first time scale divided by the time resolution of the detection data of the radar.

According to an aspect of the present disclosure, n=2^{m}, m being a positive integer.

According to an aspect of the present disclosure, the intensity information includes a trigger number of a detector unit.

According to an aspect of the present disclosure, a memory has a storage unit corresponding to each first time scale, and step S102 includes: storing the intensity information in two storage units corresponding to the two first time scales adjacent to the time information according to the first weight and the second weight.

According to an aspect of the present disclosure, step S102 further includes: during storage of the intensity information in one of the storage units according to the weight,
reading a value stored in the storage unit;
accumulating a value obtained by calculating the intensity information according to the weight to the read value; and
writing the accumulated result into the storage unit.

According to an aspect of the present disclosure, the storage method further includes: assigning an additional storage address to one of the storage units from a reserved register when it is determined that the storage unit has overflowed or is about to overflow.

According to an aspect of the present disclosure, the reserved register includes N groups of registers, N being a preset value, and each group of the registers being used for a storage unit that has overflowed or is about to overflow.

The present disclosure provides a data processing method for a lidar, including:
S201: acquiring a receipt moment and an intensity information of an optical signal;
S202: determining a time information based on a transmission moment of a detection pulse and the receipt moment;
S203: storing the intensity information with a first time precision according to a weight of the time information,
the first time precision being a time interval between any two adjacent first time scales, and being n times a time resolution of the detection data of a radar, and n>1; and
the weight being associated with a time interval between the time information and at least one first time scale.

According to an aspect of the present disclosure, the lidar performs a plurality of sweeps in a field of view, and step S203 includes: accumulating and storing an intensity information obtained by the plurality of sweeps with the first time precision.

According to an aspect of the present disclosure, the data processing method further includes:
reading a value stored in a storage unit corresponding to each first time scale after the plurality of sweeps are completed;
calculating a center of gravity of the value on a time axis; and
using the center of gravity as a time of flight (TOF).

According to an aspect of the present disclosure, the data processing method further includes:
reading a value stored in a storage unit corresponding to each first time scale after the plurality of sweeps are completed, to acquire a leading edge time of an echo pulse,
the leading edge time being obtained by:
comparing values corresponding to a leading edge of the echo pulse with a preset threshold, and using time information corresponding to a value with an intensity equal to the preset threshold as the leading edge time.

The present disclosure further provides a lidar, including:
a transmitter module, including a plurality of light emitters, and configured to transmit a laser detection pulse;
a detector module, including a plurality of detector units, and configured to receive an echo of the laser detection pulse reflected by a target object and convert the echo to an electrical signal;
a sampler device, configured to convert the electrical signal to a digital signal; and
a processor device, coupled to the sampler device and configured to: determine a detection data according to the digital signal, the detection data including a time information and an intensity information corresponding to the time information, and store the intensity information with a first time precision according to a weight of the time information;
the first time precision being a time interval between any two adjacent first time scales, and being n times a time resolution of the detection data of a radar, and n>1; and the weight being associated with a time interval between the time information and at least one first time scale.

According to an aspect of the present disclosure, the lidar is configured to perform a plurality of sweeps in a field of view, and the processor device is configured to accumulate and store an intensity information obtained by the plurality of sweeps with the first time precision.

According to an aspect of the present disclosure, the processor device is further configured to:
read a value stored in a storage unit corresponding to each first time scale after the plurality of sweeps are completed;
calculate a center of gravity of the value on a time axis; and
use the center of gravity as a time of flight (TOF).

According to an aspect of the present disclosure, the processor device is further configured to:
read a value stored in a storage unit corresponding to each first time scale after the plurality of sweeps are completed, to acquire a leading edge time of an echo pulse,
the leading edge time being obtained by:
comparing values corresponding to a leading edge of the echo pulse with a preset threshold, and using a time information corresponding to a value with an intensity equal to the preset threshold as the leading edge time.

According to an aspect of the present disclosure, the plurality of light emitters transmit detection beams to different fields of view, and the plurality of fields of view constitute a detection range of the lidar.

According to an aspect of the present disclosure, the detector unit includes a detector unit based on a Geiger mode, and the sampler device includes a time-to-digital converter (TDC).

According to an aspect of the present disclosure, each of the light emitters successively transmits a detection beam to a corresponding field of view, and after one of the light emitters transmits the detection beam, at least one detector unit corresponding to the field of view of the light emitter is activated to start detection.

The present disclosure further provides a computer-readable storage medium, having computer instructions stored thereon, the computer instructions, when executed by a processor, implement the above storage method.

### BRIEF DESCRIPTION OF THE DRAWINGS

The drawings forming a part of the present disclosure are used to provide further understanding of the present disclosure, and the exemplary embodiments and description of the present disclosure are used to explain the present disclosure but do not constitute an improper limitation on the present disclosure. In the drawings:

FIG. 1 shows trigger of a single photon avalanche diode during plurality of detection sweeps of a lidar;

FIG. 2 shows a histogram formed after accumulation of a plurality of sweeps;

FIG. 3 shows a data storage method according to the prior art;

FIG. 4 shows a storage method for a detection data of a radar according to an embodiment of the present disclosure;

FIG. 5 shows a detector unit of a lidar according to an embodiment of the present disclosure;

FIG. 6 and FIG. 7 are specific schematic diagrams of a storage way according to a preferred embodiment of the present disclosure;

FIG. 8 is a schematic diagram of a storage effect according to an embodiment of the present disclosure;

FIG. 9 is a schematic diagram of a memory assignment way according to a preferred embodiment of the present disclosure;

FIG. 10 shows a data processing method for a lidar according to an embodiment of the present disclosure; and

FIG. 11 is a block diagram of a lidar according to an embodiment of the present disclosure.

### DETAILED DESCRIPTION

Only some exemplary embodiments are briefly described below. As a person skilled in the art can realize, the described embodiments may be modified in various different ways without departing from the spirit or the scope of the present disclosure. Therefore, the drawings and the description are to be considered as illustrative in nature but not restrictive.

In the description of the present disclosure, it should be understood that orientation or position relationships indicated by terms such as “center”, “longitudinal”, “transverse”, “length”, “width”, “thickness”, “upper”, “lower”, “front”, “rear”, “left”, “right”, “vertical”, “horizontal”, “top”, “bottom”, “interior”, “exterior”, “clockwise”, and “counterclockwise” are based on orientation or position relationships shown in the drawings, are merely used for facilitating the description of the present disclosure and simplify the description, instead of indicating or implying that the indicated apparatus or element needs to have particular orientations or be constructed and operated in particular orientations, and therefore cannot be construed as a limitation on the present disclosure. Furthermore, the terms “first” and “second” are merely used for descriptive purpose, and should not be interpreted as indicating or implying relative significance or implicitly indicating a number of the indicated technical features. Thus, features defined by “first” and “second” may explicitly or implicitly include one or more features. In the description of the present disclosure, unless otherwise explicitly specified, “multiple” means two or more than two.

In the description of the present disclosure, it should be noted that unless otherwise specified or defined, terms such as “mount”, “couple”, and “connect” should be understood in a broad sense, for example, a fixed connection, a detachable connection; or an integral connection, or a mechanical connection, or an electrical connection or communication with each other; or a direct connection, an indirect connection through an intermediate medium, internal communication between two elements, or an interaction relationship between two elements. A person of ordinary skill in the art may understand the specific meanings of the above terms in the present disclosure according to specific situations.

In the present disclosure, unless otherwise explicitly specified and defined, a first feature being “over” “below” a second feature may mean that the first feature and the second feature are in direct contact, or the first feature and the second feature are not in direct contact but are in contact through another feature therebetween. Moreover, the first feature being “over”, “above”, and “on” the second feature includes that the first feature is directly above or obliquely above the second feature, or merely means that the first feature has a larger horizontal height than the second feature. The first feature being “under”, “below”, and “underneath” the second feature includes that the first feature is directly below or obliquely below the second feature, or merely means that the first feature has a smaller horizontal height than the second feature.

Many different implementations or examples are provided in the following disclosure to implement different structures of the present disclosure. To simplify the disclosure of the present disclosure, components and settings in particular examples are described below. Certainly, they are merely examples and are not intended to limit the present disclosure. In addition, the present disclosure may repeat reference numerals and/or reference letters in different examples. The repetition is for purpose of simplification and clarity, but does not indicate a relationship between the various embodiments and/or settings discussed. Moreover, the present disclosure provides examples of various particular processes and materials, but a person of ordinary skill in the art may realize application of other processes and/or use of other materials.

Preferred embodiments of the present disclosure are described below with reference to the drawings. It should be understood that the preferred embodiments described herein are merely used for illustrating and explaining the present disclosure and are not used for limiting the present disclosure.

In time-to-digital converters (TDCs) of certain lidars, each time scale of a time resolution needs to be configured with a corresponding storage location. Number information cnt of all triggered SPADs obtained after a plurality of measurements is stored at the storage location corresponding to the moment. Since a time resolution of the TDC is up to the order of picoseconds (ps), a register with a very large storage space is required. Detailed explanation is as follows.

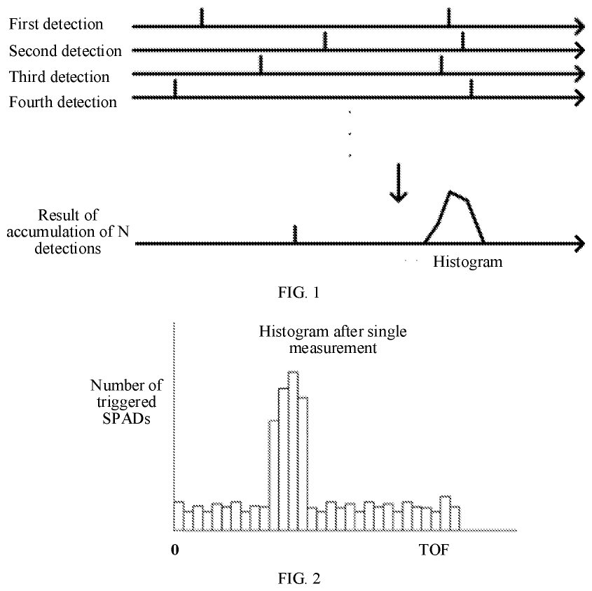

An avalanche effect of the SPAD may be triggered by a single photon. Therefore, the SPAD is easily affected by ambient light noise. Moreover, photon detection efficiency (PDE) of the SPAD at a frequently-used optical band of detection of a lidar is low, and an intensity of a signal obtained by a single detection is very weak. As shown in FIG. 1, in a detection sweep, only a few triggers may occur within a detection time window (two triggers in FIG. 1), and whether the signal is an echo signal or ambient light noise cannot be distinguished. In order to improve the long-range performance of the lidar and reduce the impact of noise, as shown in FIG. 1, the lidar may repeat a measurement a plurality of times (one measurement is referred to as a sweep, and the measurement may be repeated 400-500 times or more or less times) during a single detection of the same field of view. Results of the plurality of measurements or sweeps may be accumulated to obtain a histogram, and thereby measure a distance by using the histogram. Then a point on point cloud of the lidar is obtained.

In a single sweep, a controller of the lidar activates a portion of macro pixels (in one row or one column or any shape of interest) by supplying a high voltage to the SPAD, and then a synchronization signal is sent to inform a laser emitter at an emitting end is ready to emit light, the laser emitter at the emitting end transmits an optical pulse for detection at a moment tₐ (a means an a^{th} sweep). The optical pulse encounters an external obstacle, and is reflected by the obstacle and returns to the lidar, and can be received by a photodetector at a receiving end. When the photodetector is an array of SPADs, once the SPAD receive a photon, the SPADs generate avalanche electrical signals, which are transmitted to the TDC. The TDC outputs a time signal t₁ₐ indicating when the SPADs are triggered and a number signal cnt₁ₐ indicating a number of SPADs triggered at the same moment (1a means the first trigger of the a^{th} sweep), a timestamp₁ₐ (briefly referred to as tp₁ₐ below) of t₁ₐ-tₐ is calculated through a subtraction program, and tp₁ₐ and the trigger number cnt₁ₐ signal of the timestamp are transmitted and stored in a memory. Each macro pixel includes a plurality of SPADs, and the SPADs may perform detection again after a dead time. Therefore, in one sweep, it is possible that at another moment the SPAD may be triggered again, and the memory stores tp₂ₐ and cnt₂ₐ of the current trigger (2a means the second trigger of the a^{th} detection). A plurality of triggers in one sweep need to be stored according to a time information.

In a next sweep b, the controller of the lidar sends, according to a preset procedure, a signal again to control the emitter to transmit a detection light pulse at a moment t_{b}. Once the SPAD receives a photon, avalanche electrical signals are sent to the TDC. The TDC outputs a time signal t_{1b} indicating when the SPAD is triggered and a number signal cnt_{1b} indicating a number of SPADs triggered at the same moment (the first trigger of the b^{th} sweep), and subsequently the memory stores a timestamp_{1b} t_{1b}-t_{b} (referred to as tp_{1b} below) of the trigger time of the SPADS and the trigger number cnt_{1b} signal of the timestamp. Each macro pixel includes a plurality of SPADs, and the SPADs may perform detection again after a dead time. Therefore, in one sweep, it is possible that at another moment the SPAD may be triggered again, and the memory stores tp_{2b} and cnt_{2b} of the current trigger.

In hundreds of measurements, the trigger number cnt obtained by each measurement is stored in the corresponding memory location according to the timestamp. When a new trigger number cnt arrives at the corresponding location of the same timestamp, the original stored value and the new trigger number cnt are accumulated and then updated to the location. After accumulation of a plurality of sweeps, a histogram is stored in the memory, as shown in FIG. 2. The histogram shows a sum of trigger numbers cnt corresponding to different timestamps on a time axis. Therefore, a time information corresponding to the echo may be obtained by calculating a center of gravity or a leading edge time by using the histogram, which may be used as a time of flight (TOF) for distance calculation to generate a point on the point cloud.

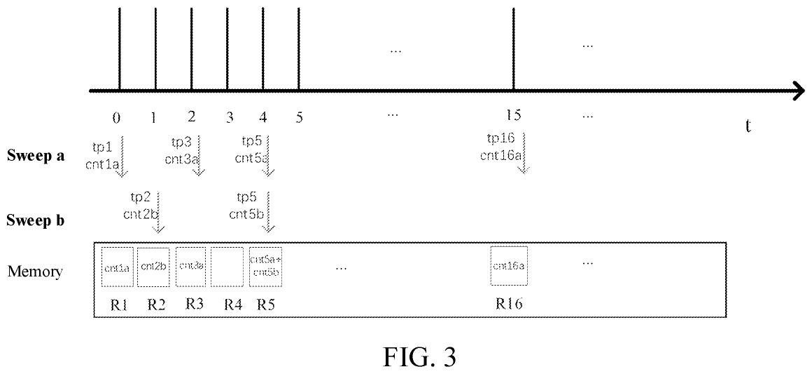

A data storage method is shown in FIG. 3. An abscissa is time t, a scale interval of the abscissa is a resolution of the TDC, and each time scale corresponds to a storage location R (a register). For example, in a certain detection sweep a, the SPAD trigger occurs at a time scale 0. A timestamp tp₁ (trigger time—current transmission time) and trigger number information cnt₁ₐ are calculated according to the transmission time and a trigger time of TDC transmission, and cnt₁ₐ is stored at a storage location R1 corresponding to the moment tp₁. If the SPAD trigger occurs at a time scale 4, time information tp₅ and cnt₅ₐ are obtained, and cnt₅ₐ is stored at a storage location R5 corresponding to tp₅. In another detection sweep b, the SPAD trigger also occurred at the time scale 4. Time information tp₅ and cnt_{5b} are obtained, where cnt_{5b} also corresponds to the storage location R5. At this time, cnt₅ₐ is read, and a value obtained by adding cnt_{5b} and cnt₅ₐ is updated to R5 (with reference to FIG. 3, a represents the a^{th} detection, b represents the b^{th} detection, and the number represents the corresponding time scale and the corresponding storage location; the storage location R corresponds to the time scale in a one-to-one correspondence, the memory stores only the trigger number cnt, and the data processing circuit can obtain the time corresponding to the trigger number cnt according to the storage location when reading the data).

It may be learned from FIG. 3 that a histogram is obtained by accumulating data of many detection sweeps (400-500 sweeps). During obtaining of a point in the point cloud by accumulating the detection results of hundreds of sweeps into a histogram, a storage location corresponding to a time scale stores a sum of all trigger numbers cnt at the moment. Although the SPAD trigger does not occur at each time scale in a sweep, as shown in FIG. 3, data in a histogram is obtained by accumulating multiple detection results, and the SPAD trigger may occur at each time scale during a sweep, so that the memory receives the corresponding data. Therefore, in a TDC, each time scale needs to be configured with a corresponding storage location. All trigger numbers cnt obtained by a plurality of measurements are stored at the storage locations corresponding to moments. Since a time interval of tp, that is, a resolution of the TDC is up to the order of picosecond, a register with a very large storage space is required.

In such a storage and ranging method, since a precision unit of the timestamp is picosecond, when a long-TOF detection is required, a very large memory is required to store a complete histogram, which occupies a very large storage space. In particular, in order to improve the long-range capability, a duration of measurement and a number of repeated measurements need to be increased, which makes a requirement for the storage space increase.

The inventor of the present disclosure conceived that a corresponding storage location is unnecessarily arranged at each time scale of the time resolution of the TDC, the detection data is not stored according to the time resolution; instead, the intensity information is stored with a lower time precision according to a weight of a time information. The present disclosure adopts a data storage method using weighted accumulation, which compresses an original signal while preserving a ranging precision, thereby greatly reducing the storage space required for storing the histogram. Specifically, the data storage method using weighted accumulation can reduce a total storage space to a range of 1/10 of an original storage space.

Specifically, a time precision for storing the intensity information in the present disclosure is a first time precision, and the first time precision may be n times the time resolution of the TDC. The intensity information is optical signal intensity information corresponding to the time information. For different photodetectors, different parameters may be used to characterize the optical signal intensity. For example, if a detector is an array of SPADs, a number of SPADs triggered simultaneously corresponding to the time information may be used as the intensity information. If the detector is a silicon photomultiplier (SiPM), an output level/current intensity corresponding to the time information may be used to represent the optical signal intensity information.

Detailed description is provided below with reference to the drawings.

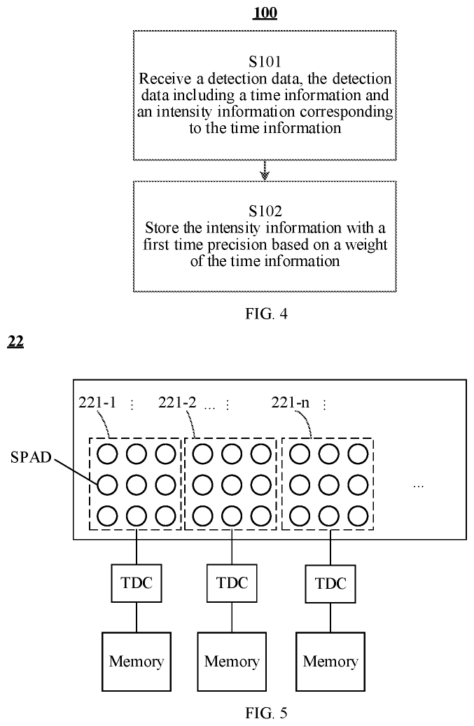

FIG. 4 shows a storage method 100 for a detection data of a lidar according to an embodiment of the present disclosure, and FIG. 5 is a schematic diagram of a detector module according to a preferred embodiment of the present disclosure. A detector module 22 of a lidar includes a plurality of detector units, and uses an SPAD as a photodetector. Each of the detector units includes a plurality of SPADs.

Refer to FIG. 4. Step S101: Receive a detection data, the detection data including a time information and an intensity information corresponding to the time information.

As shown in FIG. 5, the detector module 22 includes a plurality of detector units, which are shown as detector units 221-1, 221-2, and 221-n in FIG. 5. In the embodiment of FIG. 5, each of the detector units includes a plurality of SPADs (for example, 9 SPADs in the figure, or the number may be 3, 4, . . . , and specifically, p, where p is a positive integer greater than or equal to 1). Output terminals of the SPADs of each of the detector units are connected to a TDC. A range of a detection window of each of the detector units (that is, a time period in which the SPADs can sense an incident photon) is independently adjustable. That is to say, each of the detector units can be independently controlled to be in an active state (the SPAD is in a Geiger mode, that is, a reverse bias voltage greater than a breakdown voltage is applied on the SPAD, so that an avalanche effect of the SPAD can be triggered when the SPAD receives the photon) or an inactive state (a state in which the avalanche effect of the SPAD cannot be triggered by the photon). After the photon is incident onto the detector units 221-1, 221-2, and 221-n, the SPADs are triggered, and electrical signals are generated. Each of the detector units is coupled to the TDC, and the TDC can determine an arrival time of the photon. A data processor device (not shown in the figure) connected to the TDC can acquire an emission time of detection light, determine a time difference between the arrival time of the photon and emission time of detection light, and store a result in a memory.

Taking the detector unit shown in FIG. 5 as an example, the time information in FIG. 4 indicates a time at which one or more SPADs in a macro pixel are triggered, and the intensity information is a number of SPADs triggered at the trigger time, that is, an intensity of an optical signal is represented by the number of SPADs that are triggered. According to a preferred embodiment of the present disclosure, the time information is a timestamp when the SPADs are triggered, that is, a time difference t₁ₐ-tₐ between a time tₐ when the beam is emitted from the laser emitter and a time t₁ₐ when the SPAD is triggered.

In the embodiment of FIG. 5, the SPADs are used as an example for description. However, a person skilled in the art may easily understand that the present disclosure is not limited thereto, and other types of photodetectors may also be used, including but not limited to an avalanche photodiode (APD) and an SiPM.

Step S102: Store the intensity information with a first time precision according to a weight of the time information, the first time precision being a time interval between any two adjacent first time scales, and being n times a time resolution of the detection data of a lidar, and n>1; and the weight being associated with a time interval between the time information and at least one first time scale.

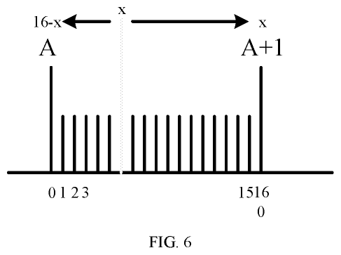

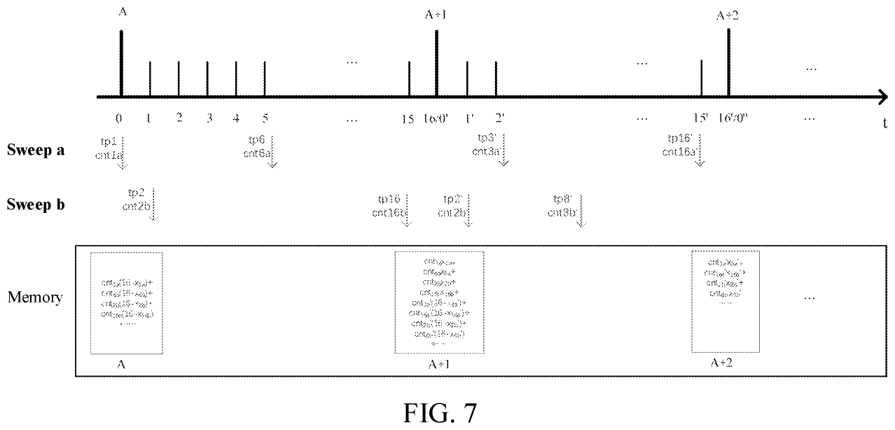

FIG. 6 and FIG. 7 are specific schematic diagrams of a storage way according to a preferred embodiment of the present disclosure. An implementation of step S102 is described in detail below with reference to FIG. 6 and FIG. 7.

In FIG. 6, an abscissa is a TOF, and a time scale interval of the abscissa is, for example, a time resolution of the lidar, such as a time resolution of the TDC, which is up to an order of picoseconds. As shown in FIG. 6, the first time scale is arranged based on the time resolution of the lidar. As shown for A and A+1 in FIG. 6, an interval between the two adjacent first time scales spans an interval of 16 time resolutions of the lidar. When a photon is detected at a moment x (for example, one or more SPADs in one macro pixel in a receiving unit 22 shown in 5 are triggered), a detected intensity value is stored according to a weight of the moment x. The moment x represents a time interval between the moment x and a first time scale A adjacent to its left divided by the time resolution of the detection data of the lidar.

A person skilled in the art may easily understand that since the time resolution of the lidar is small and the interval of the first time scale is large, a time scale corresponding to the time resolution of the lidar may be referred to as “fine scale”, and the first time scale may be referred to as a “coarse scale”.

As shown in FIG. 6, the weight of the moment x includes a first weight and a second weight, and the first weight is associated with a time interval between the moment x and one of the adjacent first time scales, and the second weight is associated with a time interval between the moment x and the another adjacent first time scale. The intensity information is stored with the first time precision according to the first weight and the second weight after the first weight and the second weight are determined.

According to a preferred embodiment of the present disclosure, the first weight is associated with a time interval between the moment x and a first time scale A adjacent to its left, and the first weight is, for example, (16−x), and the second weight is associated with a time interval between the moment x and a first time scale A+1 adjacent to its right, and the second weight is, for example, x. The moment x is represented by weights of x at two adjacent coarse scales (A, A+1). The weight of x at the coarse scale A is (16−x), and the weight of x at the coarse scale A+1 is x (x represents a time interval between the moment x and coarse scale A), to equivalently represent fine scales of the moment x. In other words, x is used as the weights, and data at the fine scales is stored at corresponding addresses of the two adjacent coarse scales to represent a value of the scale x instead of storing the scale x. The process is expressed as the following equation:

A*(16−x)+(A+1)*x=A*16+x

In the equation, the left side of an equal sign is a sum of weights applied according to a coarse scale storage and a starting value and an ending value of the coarse scale, and the right side of the equal sign is a specific value of the timestamp. The storage method using coarse scale+weight can represent the specific value of timestamp.

Similarly, when a signal obtained after triggering includes information such as the trigger number cnt representing a number or intensities of triggers in addition to the timestamp, intensity information cnt*(16−x) is added to the coarse scale A, and intensity information cnt*x is added to the coarse scale A+1, which are accumulated in a plurality of sweeps. Detailed description is provided below with reference to FIG. 7. The fine scale indicates the time resolution of the TDC. For a timestamp, a starting value of a coarse scale of the timestamp is A, and a fine scale of the timestamp is at a scale x of a corresponding 0-15 fine scale ruler in the coarse scale of the timestamp.

Referring to FIG. 7, one register is assigned for each coarse scale. A coarse scale interval of the abscissa is 16 times the resolution of the TDC. Each coarse scale corresponds to one register. During a certain sweep a, the SPAD trigger occurs at a time scale 0. Time information tp₁ (corresponding x₁ₐ is equal to 0) and trigger number information cnt₁ₐ are obtained. cnt₁ₐ* (16−x₁ₐ) is stored in a register A corresponding to the coarse scale A, and cnt₁ₐ*x₁ₐ is stored in a register A+1 corresponding to the coarse scale A+1. At another time scale 5, time information tp₆ (corresponding x6ₐ is equal to 5) and trigger number information cnt₆ₐ are obtained. The data stored in the register A corresponding to the coarse scale A is read, and is added with cnt₆ₐ* (16−x₆ₐ) and then re-stored in the register A. The data in the register A+1 corresponding to the coarse scale A+1 is read, and is added with cnt₆ₐ*x₆ₐ and then re-stored in the register A+1. Within a coarse scale time (including the 0-15th fine scales), all trigger number information cnt is weighted, and is stored in the registers corresponding to storage locations A and A+1 after being summed with the original data. Trigger number information cnt in a next coarse scale time is stored in registers corresponding to the coarse scale A+1 and a coarse scale A+2 after being weighted. For example, if the SPAD trigger occurs at a moment 2′, time information tp₃′ and cnt₃ₐ′ is obtained, and the data stored in the register A+1 corresponding to the coarse scale A+1 is added with cnt₃ₐ′*(16−x₃ₐ′), and cnt₃ₐ′*x₃ₐ′ is stored in the register A+2 corresponding to the coarse scale A+2.

During a next sweep b, received signals tp₂ and cnt_{2b} are respectively assigned with weights cnt_{2b}*(16−x_{2b}) and cnt_{2b}*x_{2b} at the coarse scales A and A+1, and are stored in the registers corresponding to coarse scales A and A+1 after summed with the original stored data. A histogram is obtained by accumulating data from many sweeps. In a plurality of sweeps, all trigger numbers cnt of corresponding triggers occurring at the moments 0-15 are stored in the registers corresponding to the coarse scales A and A+1.

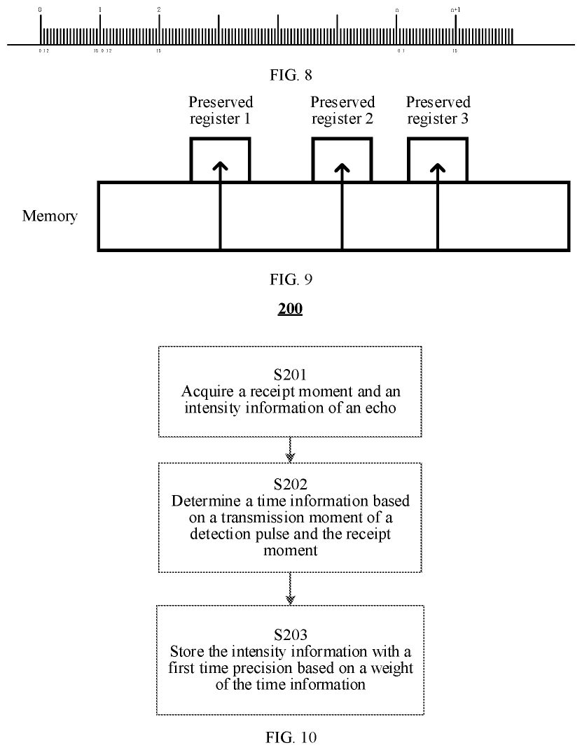

A contrast relationship between the coarse scale and the fine scale is shown in FIG. 8. Compared with a solution of arranging one register at each fine scale for data storage, in the storage method using weighted accumulation in the present disclosure, registers need to be correspondingly arranged at only a coarse scale 0−n+1 in FIG. 8. Therefore, the number of registers required is reduced to 1/16 of an original number. Although each register requires a larger bit width for storage, and occupies a larger space, the data storage method using weighted accumulation can reduce a total storage space to a range of 1/10 of the original range due to a significant reduction in storage locations required to be assigned with registers.

In the embodiment of FIG. 6 to FIG. 8, the time interval between the adjacent first time scales (coarse scales) is 16 times the time resolution (a fine scale) of the detection data of the lidar, that is, 16 is used as the weight for data compression. A person skilled in the art may easily understand that the present disclosure is not limited thereto. The weight may be any large positive integer, and preferably, 2^{m}, where m is a positive integer, thereby facilitating implementation in an FPGA or an ASIC.

In the above embodiment, the first weight is (16−x), and the second weight is x, but the present disclosure is not limited thereto. The first weight may be x, and the second weight may be (16−x), or the first weight may be 1−(x/n), and the second preset weight may be x/n, as long as the first weight is associated with the time interval between the moment x and one of the adjacent first time scale and the second weight is associated with the time interval between the moment x and the another adjacent first time scale.

The data storage method of the present disclosure can maintain a ranging precision while reducing a storage space. Detailed description is provided below.

For example, in FIG. 6 and FIG. 8, a 4-bit width (that is, 16 fine scales form a coarse scale) is used for storage, and an echo arrival time is calculated by using a center of gravity method. 16 time fine scales are accumulated into a coarse scale, and a number of photons arriving at a k^{th} fine scale between a coarse scale nth and a (n+1)^{th} coarse scale is recorded as Aₖⁿ. Therefore, a center of gravity formula of photon numbers on all fine scales within the 0^{th} coarse scale to the (n+1)^{th} coarse scale on a fine coordinate scale may be obtained as follows:

$$\frac{{\sum }_{i = 0}^{n} ( {\sum }_{j = 0}^{15} ( ( 16 * i + j ) * {A}_{j}^{i} )}{{\sum }_{i = 0}^{n} {\sum }_{j = 0}^{15} {A}_{j}^{i}}$$

G0 represents an echo arrival time calculated by using the center of gravity method in case of binary storage.

After the time information and the intensity information of the photon are compressed and stored through weighted accumulation by using the above storage method 100, a corresponding weight value Bi assigned to an i^{th} coarse scale is as follows:

When i>0 and i<n+1,

$$Bi = {\sum }_{j = 0}^{15} ( j * {A}_{j}^{i - 1} ) + {\sum }_{j = 0}^{15} ( ( 16 - j ) * {A}_{j}^{i} ) \\ B 0 = {\sum }_{j = 0}^{15} ( ( 16 - j ) * {A}_{j}^{0} ) \\ B ( n + 1 ) = {\sum }_{j = 0}^{15} ( j * {A}_{j}^{n} )$$

A center of gravity formula after weighted accumulation is:

$$G 1 = \frac{{\sum }_{i = 0}^{n + 1} i * Bi}{{\sum }_{i = 0}^{n + 1} Bi} = \frac{\begin{matrix}( n + 1 ) * B ( n + 1 ) + \\ {\sum }_{i = 1}^{n} i * ( {\sum }_{j = 0}^{15} ( j * {A}_{j}^{i - 1} ) + {\sum }_{j = 0}^{15} ( ( 16 - j ) * {A}_{j}^{i} ) )\end{matrix}}{{\sum }_{i = 0}^{n} {\sum }_{j = 0}^{15} 16 * {A}_{j}^{i}}$$

G1 represents an echo arrival time calculated by using the center of gravity method in case of data storage by using the weighted accumulation method in the present disclosure. Combining alternately the numerator of the above formula according to Aⱼⁱ gives:

$$\begin{matrix}G 1 = \frac{\begin{matrix}{\sum }_{j = 0}^{15} ( j * {A}_{j}^{0} ) + ( n + 1 ) * B ( n + 1 ) + {\sum }_{i = 1}^{n} ( ( i + 1 ) * \\ {\sum }_{j = 0}^{15} ( j * {A}_{j}^{i} ) + i * {\sum }_{j = 0}^{15} ( ( 16 - j ) * {A}_{j}^{i} ) )\end{matrix}}{{\sum }_{i = 0}^{n} {\sum }_{j = 0}^{15} 16 * {A}_{j}^{i}} \\ = \frac{\begin{matrix}{\sum }_{j = 0}^{15} ( j * {A}_{j}^{0} ) + ( n + 1 ) * B ( n + 1 ) + {\sum }_{i = 1}^{n} ( ( i + 1 ) * \\ {\sum }_{j = 0}^{15} ( j * {A}_{j}^{i} ) + {\sum }_{j = 0}^{15} ( i * ( 16 - j ) * {A}_{j}^{i} ) )\end{matrix}}{{\sum }_{i = 0}^{n} {\sum }_{j = 0}^{15} 16 * {A}_{j}^{i}} \\ = \frac{{\sum }_{j = 0}^{15} ( j * {A}_{j}^{0} ) + {\sum }_{i = 1}^{n} ( {\sum }_{j = 0}^{15} ( ( 16 * i + j ) * {A}_{j}^{i} ) )}{16 * {\sum }_{i = 0}^{n} {\sum }_{j = 0}^{15} {A}_{j}^{i}} \\ = \frac{{\sum }_{i = 0}^{n} ( {\sum }_{j = 0}^{15} ( ( 16 * i + j ) * {A}_{j}^{i} ) )}{16 * {\sum }_{i = 0}^{n} {\sum }_{j = 0}^{15} {A}_{j}^{i}} \\ = \frac{G 0}{16}\end{matrix}$$

It can be determined that results of G1 and G0 are consistent. Similarly, a precision of a ranging result using a leading edge method is also free of losses caused by the compression.

Referring to FIG. 7, the data stored in the register corresponding to the coarse scale of the present disclosure is a sum of values applying weights to the trigger numbers cnt between two intervals of the coarse scale on the left and right. The value of the data stored at the location corresponding to the stronger signal will be greater, but the value of the noise outside the echo signal will not be as great. Therefore, a bit width for storing the noise does not need to be consistent with a bit width for storing the signal. According to an actual detection situation of a system, a register may require a memory bit width of 16 bits, but storage of the noise may require only a memory bit width of 8 bits.

Therefore, according to a preferred embodiment of the present disclosure, a solution for saving more register space is provided. During the whole detection period, a time span of the echo pulse is very small, and noise exits at most other locations. Therefore, assigning the 16-bit register to each coarse scale would result in some wasted space. An 8-bit register may be used. As shown in FIG. 9, the 8-bit register is sufficient to store the trigger number cnt at the noise location. However, the echo pulse may cause a bit overflow due to a large trigger number which is more than 8 bits. According to an embodiment of the present disclosure, the storage method further includes: when it is determined that one of the storage units has overflowed or is about to overflow, an additional storage address is assigned for the storage unit from a reserved register. A plurality of 8-bit registers are reserved according to a number of echoes to be detected, which are divided into N groups with M registers in each group (the total number of registers is M*N). Once a bit overflow is found during accumulation for the histogram, one group of reserved registers are assigned to the register address as a high bit, to store data in the M reserved registers. When another bit overflow occurs, another group of reserved registers are assigned to store the overflowing data, thereby avoiding echo signal losses.

According to a preferred embodiment of the present disclosure, the reserved register includes N groups of registers, where N is a preset value, and each group of the registers is used for a storage unit that has overflowed or is about to overflow. A value of N is determined according to a maximum number of echo pulses allowed by the system. For example, when the system can calculate information of up to 3 echo pulses, set N=3. M is determined according to a maximum value of data storage. For example, a maximum register of 16 bits is originally required, in this case, 32 8-bit registers may be arranged as a group of reserved registers.

In the above way, for the detection data obtained by the plurality of sweeps, the intensity information in the detection data is stored with the first time precision according to the weight of the time information, the histogram may be formed according to the stored data, and the center on the time axis may be calculated by using the histogram. In this way, a more accurate location and TOF of the echo pulse can be obtained.

Therefore, the present disclosure further provides a data processing method. The data is stored in the storage unit of the memory through the storage method 100 described above. The processing method includes:
reading a value stored in a storage unit corresponding to each first time scale; and
calculating a center of gravity of the value on a time axis.

After the center of gravity of the value on the time axis is calculated, coordinates of the time axis corresponding to the center of gravity (such as coordinates of a fine scale) may be used as a TOF of an echo pulse to calculate a distance from a target object.

In another preferred embodiment, the processing method includes:
reading a value stored in a storage unit corresponding to each first time scale after the plurality of sweeps are completed; acquiring a leading edge time of the echo pulse. Specifically, values corresponding to a leading edge of the echo pulse are compared with a preset threshold, and time information corresponding to a value with an intensity equal to the preset threshold is used as the leading edge time to calculated the distance from the target object.

In a specific implementation, the preset threshold is a noise threshold.

In a specific implementation, the preset threshold is an average value of the noise threshold and a pulse peak.

The present disclosure further provides a data processing method 200 for a lidar. As shown in FIG. 10, the method includes the following steps:

Step S201: Acquire a receipt moment and an intensity information of an echo. For example, the receiving unit 22 shown in FIG. 5 is used to receive the echo of the lidar. The receipt moment is a moment when SPADs in each macro pixel are triggered. The intensity information may be represented by a number of the SPADs triggered at this moment.

Step S202: Determine a time information based on a transmission moment of a detection pulse and the receipt moment.

Based on the transmission moment of the detection pulse and the receipt moment of the echo, a time difference, namely, a TOF of the echo, may be obtained as the time information.

Step S203: Store the intensity information with a first time precision according to a weight of the time information, where the first time precision is a time interval between any two adjacent first time scales, and is n times a time resolution of the detection data of a lidar, and n>1; and the weight being associated with a time interval between the time information and at least one first time scale.

As described above with reference to FIG. 6 to FIG. 8, the intensity information is stored with the first time precision (which is a coarser precision but not a precision consistent with a precision of the time resolution of the lidar or a precision of the time resolution that the lidar system can achieve) according to the weight of the time information.

According to a preferred embodiment of the present disclosure, when the lidar performs detection in a field of view (such as a part in a three-dimensional environment), the lidar performs a plurality of sweeps in the field of view, and obtains distance information of the part according to detection information obtained by the plurality of sweeps. Step S203 includes: accumulating and storing intensity information obtained by the plurality of sweeps with the first time precision.

After the plurality of sweeps are completed, a value stored in the storage unit corresponding to each first time scale is read, and then, for example, a histogram may be generated, a center of gravity of the value on the time axis is calculated, time information corresponding to the center of gravity is used as a TOF, and a distance corresponding to the TOF is calculated.

In another preferred embodiment, a value stored in a storage unit corresponding to each first time scale is read after the plurality of sweeps are completed, and a leading edge time of an echo pulse is acquired. Specifically, values corresponding to a leading edge of the echo pulse are compared with a preset threshold, and time information corresponding to a value with an intensity equal to the preset threshold is used as the leading edge time.

In a specific implementation, the preset threshold is a noise threshold.

In a specific implementation, the preset threshold is an average value of the noise threshold and a pulse peak.

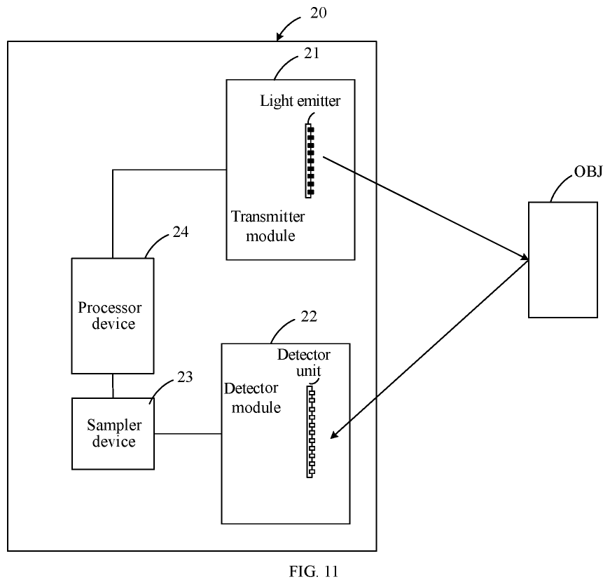

The present disclosure further provides a lidar 20, as shown in FIG. 11. The lidar 20 includes a transmitter module 21, a detector module 22, a sampler device 23, and a processor device 24. The transmitter module 21 includes a plurality of light emitters (such as a plurality of laser emitters), which are configured to transmit laser detection pulses L to a three-dimensional environment to detect a target object. The detector module 22 includes a plurality of detector units and is configured to receive echo of the laser detection pulse reflected by the target object and convert the echo signal to an electrical signal. The detector module 22, for example, may be the detector module 22 shown in FIG. 5, which includes a plurality of detector units composed of SPADs. The sampler device converts the electrical signal to a digital signal, and/or may obtain an arrival time of the echo. According to a preferred embodiment of the present disclosure, the sampler device may include an analog-to-digital converter (ADC) and a TDC. The processor device 24 is coupled to the sampler device 23, and may be further coupled to the light emitter 21, and is configured to: determine a detection data according to the digital signal, the detection data including a time information and an intensity information corresponding to the time information, and store the intensity information with a first time precision according to a weight of the time information; the first time precision being a time interval between any two adjacent first time scales, and being n times a time resolution of the detection data of a lidar, and n>1; and the weight being associated with a time interval between the time information and at least one first time scale.

According to an embodiment of the present disclosure, the lidar is configured to perform a plurality of sweeps in a field of view, and the processor device is configured to accumulate and store intensity information obtained by the plurality of sweeps with the first time precision.

According to an embodiment of the present disclosure, the processing unit is further configured to: read a value stored in a storage unit corresponding to each first time scale after the plurality of sweeps are completed; calculate a center of gravity of the value on a time axis; and use time information corresponding to the center of gravity as a TOF.

According to another embodiment of the present disclosure, the processing unit is further configured to: read a value stored in a storage unit corresponding to each first time scale after the plurality of sweeps are completed; a leading edge time of an echo pulse is acquired. Specifically, values corresponding to a leading edge of the echo pulse are compared with a preset threshold, and time information corresponding to a value with an intensity equal to the preset threshold is used as the leading edge time.

In a specific implementation, the preset threshold is a noise threshold.

In a specific implementation, the preset threshold is an average value of the noise threshold and a pulse peak.

According to an embodiment of the present disclosure, the plurality of light emitters correspond to different field of views, that is, the plurality of light emitters transmit detection beams to different field of views, and the plurality of field of views constitute a detection range of the lidar.

According to an embodiment of the present disclosure, each of the light emitters successively transmits a detection beam to a corresponding field of view, and after one of the light emitters transmits the detection beam, at least one detector unit corresponding to the field of view of the light emitter is activated and starts detection.

The present disclosure further relates to a computer-readable storage medium, including computer-executable instructions stored thereon, the computer-executable instructions, when executed by a processor, implementing the storage method 100 described above.

Finally, it should be noted that: the above description is merely preferred embodiments of the present disclosure, and is not intended to limit the present disclosure. Although the present disclosure has been described in detail with reference to the above embodiments, a person of ordinary skill in the art may make modifications to the technical solutions described in the above embodiments, or make equivalent replacements to some technical features in the technical solutions. Any modification, equivalent replacement, improvement, and the like made within the spirit and principle of the present disclosure shall fall within the protection scope of the present disclosure.

1. A storage method for a detection data of a lidar, comprising:
receiving a detection data, the detection data comprising a time information and an intensity information corresponding to the time information; and
storing the intensity information with a first time precision based on a weight of the time information,
wherein the first time precision being a time interval between any two adjacent first time scales, and being n times a time resolution of a detection data of a lidar, and n>1; and
the weight being associated with a time interval between the time information and at least one first time scale.

2. The storage method of claim 1, wherein the weight comprises a first weight and a second weight, the first weight being associated with a time interval between the time information and one adjacent first time scale, the second weight being associated with a time interval between the time information and another adjacent first time scale, and storing the intensity information with the first time precision based on the weight of the time information comprising: storing the intensity information with the first time precision based on the first weight and the second weight.

3. The storage method of claim 2, wherein the first weight is n−x, and the second weight is x, wherein x represents a time interval between the time information and an adjacent first time scale divided by the time resolution of the detection data of the lidar.

4. The storage method of claim 3, wherein the first weight is a weight of the time information corresponding to a left adjacent first time scale, and the second weight is a weight of the time information corresponding to a right adjacent first time scale, wherein x represents a time interval between the time information and the left adjacent first time scale divided by the time resolution of the detection data of the lidar.

5. The storage method of claim 2, wherein the first weight is 1−(x/n), and the second weight is x, x representing a time interval between the time information and a left adjacent first time scale divided by the time resolution of the detection data of the lidar.

6. The storage method of claim 1, wherein n=2^{m} and m is a positive integer.

7. The storage method of claim 1, wherein the intensity information comprises a trigger number of a detector unit.

8. The storage method of claim 2, wherein a memory has a storage unit corresponding to each first time scale, and storing the intensity information with the first time precision based on the weight of the time information comprises: storing the intensity information in two storage units corresponding to the two first time scales adjacent to the time information based on the first weight and the second weight.

9. The storage method of claim 8, wherein storing the intensity information with the first time precision based on the weight of the time information further comprises: during storage of the intensity information in one of the storage units based on the weight,
reading a value stored in the storage unit;
accumulating a value obtained by calculating the intensity information based on the weight to the read value; and
writing the accumulated result into the storage unit.

10. The storage method of claim 8, further comprising:
assigning an additional storage address to one of the storage units from a reserved register when it is determined that the storage unit has overflowed or is about to overflow.

11. The storage method of claim 10, wherein the reserved register comprises N groups of registers, N being a preset value, and each group of the registers being used for a storage unit that has overflowed or is about to overflow.

12. A data processing method for Light Detection and Ranging (lider), comprising:
acquiring a receipt moment and an intensity information of an optical signal;
determining a time information based on a transmission moment of a detection pulse and the receipt moment;
storing the intensity information with a first time precision based on a weight of the time information,
wherein the first time precision being a time interval between any two adjacent first time scales, and being n times a time resolution of a detection data of a lidar, and n>1; and
the weight being associated with a time interval between the time information and at least one first time scale.

13. The data processing method of claim 12, wherein the lidar performs a plurality of sweeps in a field of view, and storing the intensity information with the first time precision based on the weight of the time information comprises: accumulating and storing an intensity information obtained by the plurality of sweeps with the first time precision.

14. The data processing method of claim 13, further comprising:
reading a value stored in a storage unit corresponding to each first time scale after the plurality of sweeps are completed;
calculating a center of gravity of the value on a time axis; and
using the center of gravity as a time of flight (TOF).

15. The data processing method of claim 13, further comprising:
reading a value stored in a storage unit corresponding to each first time scale after the plurality of sweeps are completed, to acquire a leading edge time of an echo pulse,
the leading edge time being obtained by:
comparing values corresponding to a leading edge of the echo pulse with a preset threshold, and using a time information corresponding to a value with an intensity equal to the preset threshold as the leading edge time.

16. A lidar, comprising:
a transmitter module, comprising a plurality of light emitters, and configured to transmit laser detection pulse;
a detector module, comprising a plurality of detector units, and configured to receive an echo of the laser detection pulse reflected by a target object and convert the echo to an electrical signal;
a sampler device, configured to convert the electrical signal to a digital signal; and
a processor device, coupled to the sampler device and configured to: determine a detection data based on the digital signals, the detection data comprising a time information and an intensity information corresponding to the time information, and store the intensity information with a first time precision based on a weight of the time information,
the first time precision being a time interval between any two adjacent first time scales, and being n times a time resolution of the detection data of a lidar, and n>1; and the weight being associated with a time interval between the time information and at least one first time scale.

17. The lidar of claim 16, wherein the lidar is configured to perform a plurality of sweeps in a field of view, and the processing device is configured to accumulate and store an intensity information obtained by the plurality of sweeps with the first time precision.

18. The lidar of claim 17, wherein the processor device is further configured to:
read a value stored in a storage unit corresponding to each first time scale after the plurality of sweeps are completed;
calculate a center of gravity of the value on a time axis; and
use the center of gravity as a time of flight (TOF).

19. The lidar of claim 17, wherein the processor device is further configured to:
read a value stored in a storage unit corresponding to each first time scale after the plurality of sweeps are completed, to acquire a leading edge time of an echo pulse,
the leading edge time being obtained by:
comparing values corresponding to a leading edge of the echo pulse with a preset threshold, and using a time information corresponding to a value with an intensity equal to the preset threshold as the leading edge time.

20. The lidar of claim 16, wherein the plurality of light emitters transmit detection beams to different fields of view, and the different fields of view constitute a detection range of the lidar.

21. The lidar of claim 16, wherein the detector unit comprises a detector based on a Geiger mode, and the sampler device comprises a time-to-digital converter (TDC).

22. The lidar of claim 16, wherein each of the light emitters successively transmits a detection beam to a corresponding field of view, and after one of the light emitters transmits the detection beam, at least one detection unit corresponding to the field of view of the light emitters is activated to start detection.

23. A computer-readable storage medium, comprising computer-executable instructions stored thereon, the computer-executable instructions, when executed by a processor, implementing the storage method of claim 1.
